(19) United States
(12) Patent Application Publication
(10) Pub. No.: US 2024/0290536 A1
(43) Pub. Date: Aug. 29, 2024

(54) CELLULAR FLYBACK TRANSFORMER

(71) Applicant: Apple Inc., Cupertino, CA (US)

(72) Inventors: Vijay G. Phadke, San Jose, CA (US); Prudhvi Mohan Maddineni, Santa Clara, CA (US)

(21) Appl. No.: 18/175,837

(22) Filed: Feb. 28, 2023

(51) Int. Cl. H01F 27/34; H01F 27/26; H01F 27/28; H01F 27/30

(52) U.S. Cl. CPC H01F 27/34; H01F 27/263; H01F 27/2823; H01F 27/306; H01F 2027/348

(57) ABSTRACT

A cellular magnetic energy storage component can include a plurality of magnetic core segments each having at least one winding disposed about at least a portion thereof; and at least one common magnetic core segment. The plurality of magnetic core segments and the at least one common magnetic core segment can be joined such that there is an air gap between a portion of each of the plurality of magnetic core segments and the common magnetic core segment; and magnetic flux in the at least one common magnetic core segment induced by one or more of the at least one windings substantially cancels a corresponding magnetic flux in the common magnetic core segment induced by one or more other at least one windings. The cellular magnetic energy storage component can be an inductor or a flyback transformer.

### BACKGROUND

Flyback converters are used in many electronic device power supplies, particularly but not exclusively those with relatively low power requirements. Advantages of flyback converters that lead to their widespread use can include design simplicity, low component count, ability to operate over wide input and output voltage ranges, low cost, etc. One characteristic of at least some flyback converters is the use of an air gap in the core of the flyback transformer (coupled inductors). For example, many flyback transformer/coupled inductor designs place such an airgap in the center leg of the magnetic core of the flyback transformer/coupled inductors.

In some applications, this air gap can cause a fringing flux field that can pull current flowing through the windings towards the air gap, reducing utilization of the full wire cross section. This phenomenon can be characterized by a higher ratio of AC resistance (ACR or Rac) to DC resistance (DCR or Rdc) of the respective windings. Some implementations use Litz wire (twisted sets of thin wires) to overcome this effect to a degree, but increased losses may still result. Additionally, the air gap fringing flux field can prevent the use of paralleled windings to reduce conduction losses. In many cases, multiple windings are placed in different layers and connected in parallel, the current will not be equally shared between them. Rather, the winding closest to the air gap will carry the majority of the load current. In some cases, the use of parallel windings can cause additional circulating eddy current losses further reducing efficiency of the converter.

### SUMMARY

Thus, it would be desirable to provide improved flyback converter constructions, and particularly flyback transformer (coupled inductor) constructions that can potentially address the above described issues relating to the fringing flux field associated with the airgap of the flyback transformer (coupled inductor) core.

A cellular flyback transformer can include a first magnetic core segment having a first primary winding and a first secondary winding wrapped around at least a portion of the first magnetic core segment; a second magnetic core segment having a second primary winding and a second secondary winding wrapped around at least a portion of the second magnetic core segment; and a common magnetic core segment. The first, second, and magnetic core segments can be joined such that there is a first air gap between at least a portion of the first magnetic core segment and the common magnetic core segment and a second air gap between at least a portion of the second magnetic core segment and the common magnetic core segment; and magnetic flux in the common magnetic core segment induced by at least one of the first primary or first secondary winding is equal and opposite a corresponding magnetic flux in the common magnetic core segment induced by at least one of the second primary or second secondary winding.

The first magnetic core segment and second magnetic core segment can be E-cores, and the common magnetic core segment can be an I-core. The first air gap can be between a center post of the first magnetic core segment and the common magnetic core segment, and the second air gap can be between a center post of the second magnetic core segment and the common magnetic core segment. The first primary and first secondary windings can be disposed around the center post of the first magnetic core segment, and the second primary and second secondary windings can be disposed around the center post of the second magnetic core segment. The cellular flyback transformer can be a planar transformer, and the first primary and first secondary windings and second primary and second secondary windings can be formed on respective layers of a printed circuit board. The cellular flyback transformer can be a wire-wound transformer, and the first primary and first secondary windings and second primary and second secondary windings can be wound about respective bobbins. The common magnetic core segment can be integral with the second magnetic core segment. The first air gap can be between a center post of the first magnetic core segment and the common magnetic core segment, and the second air gap can be between a center post of the second magnetic core segment and an additional magnetic core segment. The common magnetic core segment can have a reduced cross-sectional area relative to the first and second magnetic core segments.

The first primary winding and the second primary winding can be connected in parallel, and the first secondary winding and the second secondary winding can be connected in parallel. The first primary winding and the second primary winding can be connected in parallel, and the first secondary winding and the second secondary winding can be connected in series. The first primary winding and the second primary winding can be connected in series, and the first secondary winding and the second secondary winding can be connected in parallel. The first primary winding and the second primary winding can be connected in series, and the first secondary winding and the second secondary winding can be connected in series.

A cellular magnetic energy storage component can include a plurality of magnetic core segments each having at least one winding disposed about at least a portion thereof; and at least one common magnetic core segment. The plurality of magnetic core segments and the at least one common magnetic core segment can be joined such that there is an air gap between a portion of each of the plurality of magnetic core segments and the common magnetic core segment; and magnetic flux in the at least one common magnetic core segment induced by one or more of the at least one windings substantially cancels a corresponding magnetic flux in the common magnetic core segment induced by one or more other at least one windings. The cellular magnetic energy storage component can be an inductor or a flyback transformer.

One or more of the at least one windings can be connected in parallel and/or one or more of the at least one windings can be connected in series. One or more of the at least one windings can be formed on a printed circuit board. One or more of the at least one windings can be wound about a bobbin. The at least one common magnetic core segment can be integral with at least one of the plurality of magnetic core segments. The at least one common magnetic core segment can have a reduced cross-sectional area relative to the plurality of magnetic core segments.

### BRIEF DESCRIPTION OF THE DRAWINGS

FIG. 1 illustrates a flyback converter with synchronous rectification.

FIG. 2A-2D illustrate electrical schematics of various configurations of multiple flyback transformers.

FIG. 3 illustrates construction of a cellular flyback transformer.

FIG. 4 illustrates printed circuit board (“PCB”) layers of a planar transformer.

FIG. 5 illustrates a PCB-based planar transformer.

FIG. 6 illustrates a cellular PCB-based planar transformer.

FIG. 7 illustrates an alternative cellular PCB-based planar transformer.

FIG. 8 illustrates a wire wound transformer.

FIG. 9 illustrates a wire wound cellular transformer.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

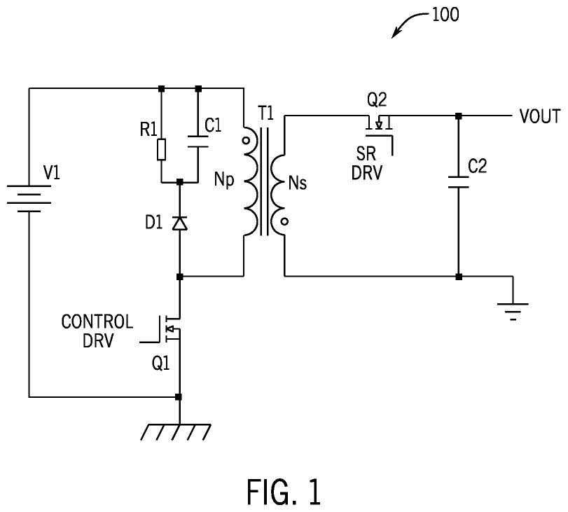

FIG. 1 illustrates an exemplary flyback converter 100 with synchronous rectification. The flyback converter receives an input voltage V1 and produces an output voltage Vout. The output voltage can be produced by alternating control switch Q1 between an on state and an off state. In the on state of control switch Q1, current flows from the input voltage source V1, through the primary winding Np of flyback transformer T1. When transitioning to the off state, the current through the inductance of primary winding Np cannot change instantly, which causes a reversal of the voltage appearing across primary winding Np. As a result, the voltage across coupled secondary winding Ns also reverses, driving a current to Vout. A rectifier device Q2 (in this case a synchronous rectifier device) can be provided on the output to allow current flow to the load, while preventing reverse current flow from the load. Alternatively, as passive rectification device (e.g., a diode) could be used, although a synchronous rectifier may provide higher operating efficiency. The output voltage Vout may be further supported by an output capacitor C2.

Turning back to the primary side, when control switch Q1 turns off, the continued current flow through primary winding Np can flow through diode D1 (forward biased by the voltage reversal discussed above). This current has the effect of storing energy in clamp capacitor C1 and/or dissipating energy through resistor R1. Diode D1, resistor R1, and capacitor C1 thus make up a clamp/energy recovery circuit. Other clamp circuit designs, including both active clamps (i.e., clamp circuits with active switching elements) and passive clamps (i.e., clamp circuits using diodes or other passive control mechanisms) may also be provided. Control signals for the flyback converter, including drive signals for control switch Q1, synchronous rectifier switch Q2, and any active clamp control devices (not shown) can be provided by controller circuitry not shown. The controller circuitry can be implemented using any combination of analog, digital, and/or programmable circuitry implemented using any combination of discrete or integrated circuits. The controller circuitry can respond to one or more sensor inputs, such as current sensors, voltage sensors, etc. to regulate one or more parameters of the circuit, such as output voltage, output current, etc. using varying control loops, control strategies, etc. Many different implementations of such controller circuitry, control loops, and control strategies are possible and may be used in connection with the magnetic circuit structures described herein.

As described above, flyback transformer T1 can include a primary winding Np and a secondary winding Ns. Flyback transformer T1 can differ from “conventional” transformers in that it is used as an energy storage device. More specifically, energy can be stored in the transformer during the on time of control switch Q1 and can be discharged from the transformer during the off time of control switch Q1. Thus, flyback transformer may also be thought of as a pair of mutually coupled inductors, i.e., the primary winding Np and the secondary winding Ns. As used herein, flyback transformer and coupled inductors may be considered as synonyms. Various physical constructions of flyback transformers can be used. One technique is to have the primary winding and secondary winding wound on a common magnetic core. Both/each of the primary and secondary windings can be wire wound or can be made of winding turns on a printed circuit board (as described in greater detail below). The magnetic core can be constructed from various magnetic materials, such as ferrites, transformer steel, and the like.

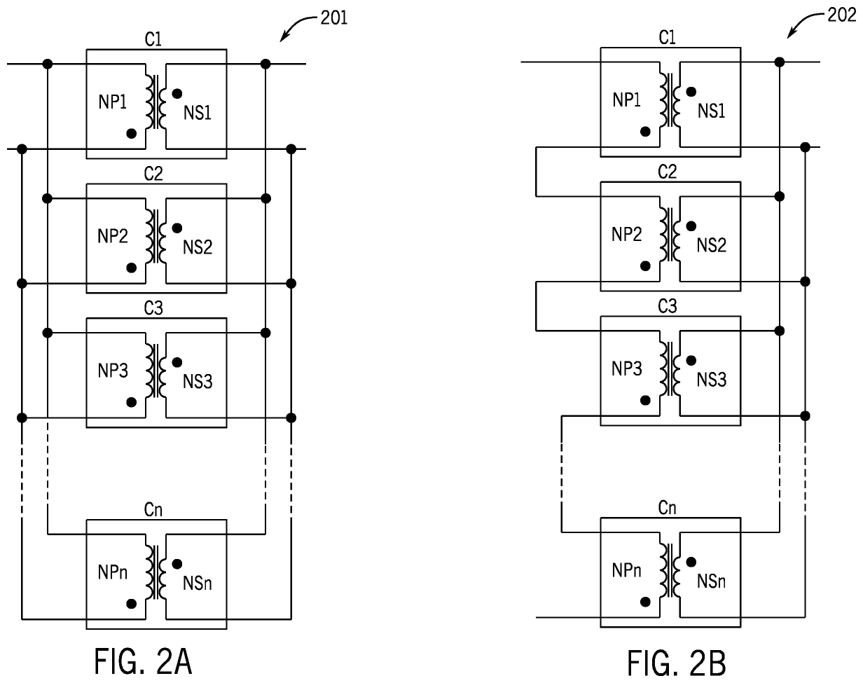

As described above, flux fringing fields associated with the magnetic core air gap of a flyback transformer can affect the spatial distribution of current within the transformer windings (whether primary or secondary) and/or the distribution of current between paralleled sets of windings (whether primary or secondary) in a way that leads to increased losses. In at least some applications, these issues can be addressed by distributing the air gap into multiple cells. Each cell can have a primary winding and a secondary winding wound on a magnetic core, and multiple cells can be joined such that there is a common magnetic core segment between adjacent cells (as described further below). Each cell can thus act as a separate flyback transformer (coupled inductor). Substantially equal power sharing among the cells can be achieved, as well as allowing for various series, parallel, or series-parallel combinations of the cells as illustrated in FIGS. 2A-2D.

FIG. 2A illustrates a configuration 201 in which a plurality of flyback transformer cells C1, C2, C3, . . . , Cn are provided. Each cell has one primary winding (Npx) and one secondary winding (Nsx). The primary winding of each cell (NP1, NP2, NP3, . . . , NPn) can have the same number of turns as the primary winding Np of a conventional flyback transformer T1. Similarly, the secondary winding of each cell (NS1, NS2, NS3, . . . , NSn) can have the same number of turns as the secondary winding Ns of a conventional flyback transformer T1. All primary windings and all secondary windings of the cells are connected in parallel, thus the combined flyback transformer cells can have the same number of primary and secondary turns as a conventional flyback transformer, but with increased current carrying capability, while potentially avoiding the deleterious effects discussed above.

FIG. 2B illustrates a configuration 202 in which a plurality of flyback transformer cells C1, C2, C3, . . . , Cn are provided. Each cell has one primary winding (Npx) and one secondary winding (Nsx). The primary winding of each cell (NP1, NP2, NP3, . . . , NPn) can have NP/n number of turns with respect to the primary winding Np of a conventional flyback transformer T1. Conversely, the secondary winding of each cell (NS1, NS2, NS3, . . . , NSn) can have the same number of turns as the secondary winding Ns of a conventional flyback transformer T1. All primary windings of the cells can be connected in series, and all secondary windings of the cells are connected in parallel. Thus, the combined flyback transformer cells can have the turns ratio as a conventional flyback transformer, but with increased current capability on the secondary side, while potentially avoiding the deleterious effects discussed above.

FIG. 2C illustrates a configuration 203 in which a plurality of flyback transformer cells C1, C2, C3, . . . , Cn are provided. Each cell has one primary winding (Npx) and one secondary winding (Nsx). The primary winding of each cell (Np1, Np2, Np3, . . . , Npn) can have the same number of turns as the primary winding Np of a conventional flyback transformer T1. Conversely, the secondary winding of each cell (Ns1, Ns2, Ns3, . . . , Nsn) can have Ns/n number of turns with respect to the secondary winding Ns of a conventional flyback transformer T1. All primary windings of the cells are connected in parallel, and all secondary windings of the cells are connected in series. Thus, the combined flyback transformer cells can have the same turns ratio as a conventional flyback transformer, but with increased current capability on the primary side, while potentially avoiding the deleterious effects discussed above.

FIG. 2D illustrates a configuration 204 in which a plurality of flyback transformer cells C1, C2, C3, . . . , Cn are provided. Each cell having one primary winding (Npx) and one secondary winding (Nsx). The primary winding of each cell (Np1, Np2, Np3, . . . , Npn) can have Np/n number of turns with respect to the primary winding Np of a conventional flyback transformer T1. Similarly, the secondary winding of each cell (Ns1, Ns2, Ns3, . . . , NSn) has Ns/n number of turns with respect to the secondary winding Ns of a conventional flyback transformer T1. All primary and secondary windings of the cells are connected in series. Thus, the combined flyback transformer cells can have the same turns ratio as a conventional flyback transformer, while potentially avoiding the deleterious effects discussed above.

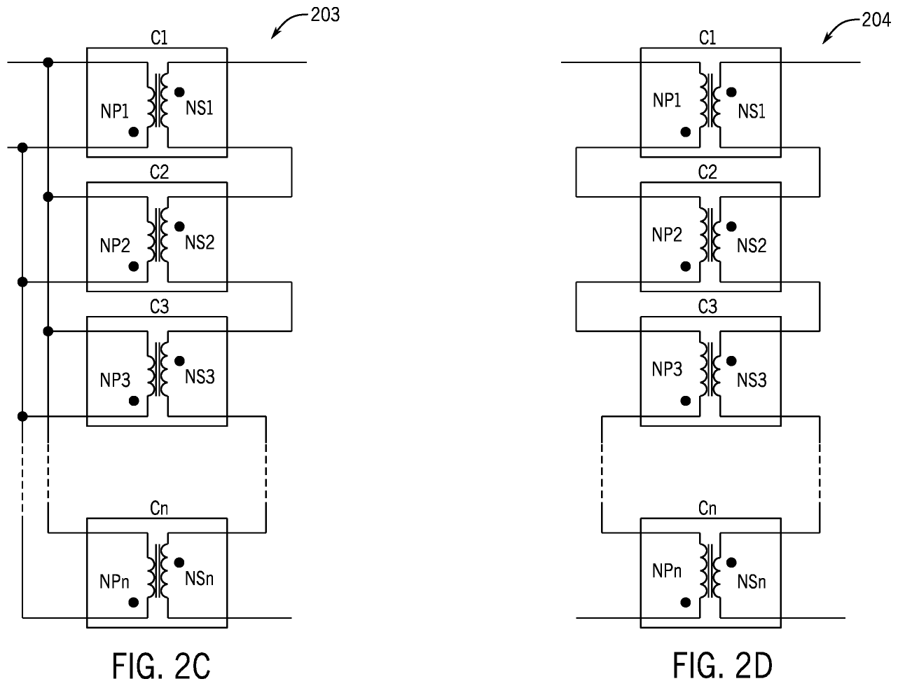

FIG. 3 illustrates basic construction of a cellular flyback transformer 300. A first flyback transformer cell can be made up of core segment 311 (e.g., an E-core), which can have a winding 317 wound about it, e.g., about a central core post of core segment 311. A second flyback transformer cell can be made up of core segment 315 (e.g., an E-core), which can have a winding 319 wound about it, e.g., about a central core post of core segment 315. A common core segment 313 (e.g., an I-core) can be provided to join the two cells. Polarity of the windings is indicated with an X, and each core segment will include an additional winding (not shown). A cellular transformer is formed by joining the cells described above, as illustrated on the right-had side of FIG. 3. The cores can be joined by any suitable mechanism, including the use of adhesives, mechanical fasteners, retaining brackets, etc.

As illustrated, air gaps 312/314 can be provided between core segments 311/315 and core segment 313 to provide an air gap for energy storage/flyback operation as described above. Current flow through winding 317 in the direction corresponding to polarity mark X (i.e., out of the X) can result in magnetic flux 316 flowing thorough core segments 311/313 in the directions indicated by the solid arrows. Similarly, current flow through winding 319 in the direction corresponding to polarity mark X (i.e., out of the X) can result in magnetic flux 318 flowing thorough core segments 315/313 in the directions indicated by the dashed arrows. The net flux through core segment 313 can be approximately zero because the fluxes flow in opposite directions, cancelling each other out. As a result, the cross-sectional area of core segment 313 can be reduced relative to the cross-sectional area of core segments 311/315, while still avoiding magnetic saturation of the core. This can reduce both the size and cost of the cellular transformer.

By constructing a cellular transformer as described above with respect to FIG. 3, cores of all cells can be magnetically coupled to make it function as a single transformer. Thus, the effective transformers as shown in FIGS. 2A-2D can be electrically equivalent to a conventional flyback transformer T1 as shown in FIG. 1. The combined primary inductance of each of the configurations can also be the same as the reference conventional flyback transformer T1. Further all topologies shown in FIGS. 2A-2D can be used in their various combinations to effectively build a cellular flyback transformer equivalent in functionality to a reference conventional flyback transformer T1.

As described above, all cells with their magnetic cores can be stacked on each other such that they have one common core limb with an adjacent core. Although E and I cores were described, a similar arrangement can be made with other core shapes/types. In any case, the cellular transformer can be constructed so that two adjacent cells with a common core limb generate the same flux in opposite directions in the common core limb. Additionally, all cells have their own discrete air gap (e.g., 312/314), which are necessary in a flyback transformer for storing energy. Thus, two functions of the common plate can be: (1) to act as a magnetic mirror and (2) to allow for distribution of a larger (e.g., longer) air gap into multiple, separated smaller (e.g., shorter) air gaps. The fringing field of each air gap is confined only to the geometry of that cell. Because the air gap of each cell can be smaller (e.g., shorter), the resultant proximity effect on the windings in each cell can be significantly reduced.

Using the above-described technique for constructing a cellular flyback transformer, the effects of fringing magnetic flux in the air gap can be substantially reduced but may not be totally eliminated. However, because the coil winding structure in each cell has identical proximity to the air gap in that cell, all coils can have equal AC resistance. Thus, if they are connected in parallel, they share the current equally, assuming they all have equal inductance. While this is theoretically true for identically configured/constructed cells, in practice, the inductance of each cell may vary, e.g., up to +/−5% causing marginally unequal power sharing. However, this effect can be minimized to the point of being negligible based on the reduction in AC resistance effects.

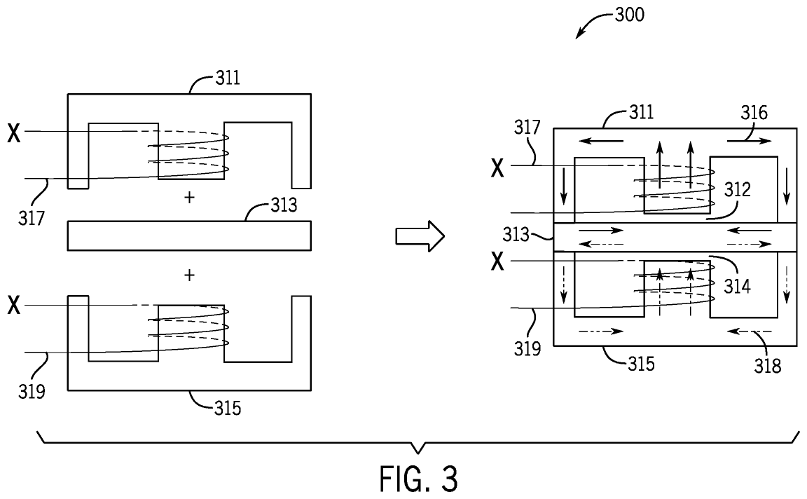

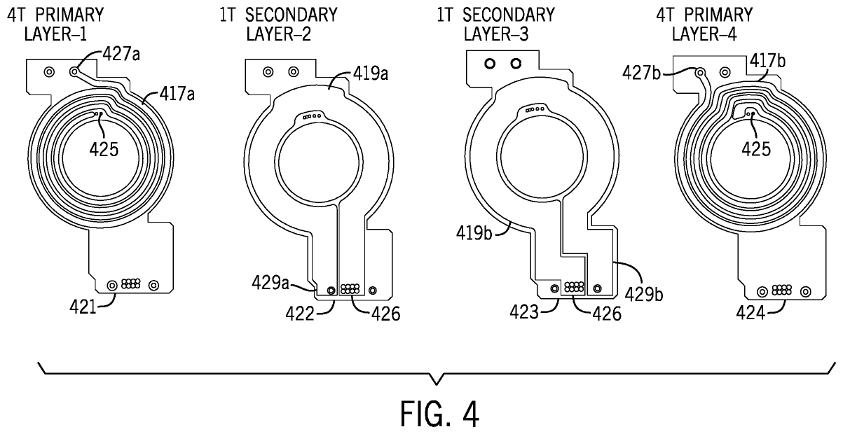

A cellular flyback transformer as described above can be implemented using a variety of configurations. One such configuration is a printed circuit board (PCB) planar transformer. FIG. 4 illustrates printed circuit board (“PCB”) layers of a planar transformer, and FIG. 5 illustrates a PCB-based planar transformer. With reference to FIG. 4, exemplary printed circuit board layers are depicted. More specifically, the printed circuit board can include four layers 421, 422, 423, and 424. Layers 421 and 424 can include a primary winding having eight turns, with four turns 417a being formed on layer 421 and four turns 417b being formed on layer 424. The two sets of turns can be series connected by vias 425, with one end of the winding being taken from terminal 427a on layer 421 and another via terminal 427b on layer 424. The secondary winding can be similarly formed and can include a two turn secondary winding made up of turn 419a on layer 422 and turn 419b on layer 423. The two turns can be series connected by vias 426, with the terminals of the secondary winding being taken by terminal 429a on layer 422 and terminal 429b on layer 423. Secondary layers 422 and 423 can be sandwiched between primary layers 421 and 424, with appropriate insulation layers added between the respective copper layers. The above-described configuration is but one example provided for context, and many other configurations, with differing numbers of layers, numbers of turns, etc. can be used with the techniques described herein.

FIG. 5 illustrates a completed planar transformer assembly 500 that can be constructed using a winding PCB 520 as described above. The planar transformer assembly can include a core formed from an E-shaped core segment 511 and an I-shaped core plate 512, with the PCB 520 being disposed about a center post (not shown due to perspective) therein. The primary winding can be connected by pins 531, and the secondary winding can be connected by pins 532, connected to respective printed circuit board terminals as described above with respect to FIG. 4. As with the figures discussed above, the configuration of FIG. 5 is just one possible configuration illustrating the basic principles, and implementations can vary in structural details, such as the exact core shapes, winding terminal placement, PCB configuration, etc.

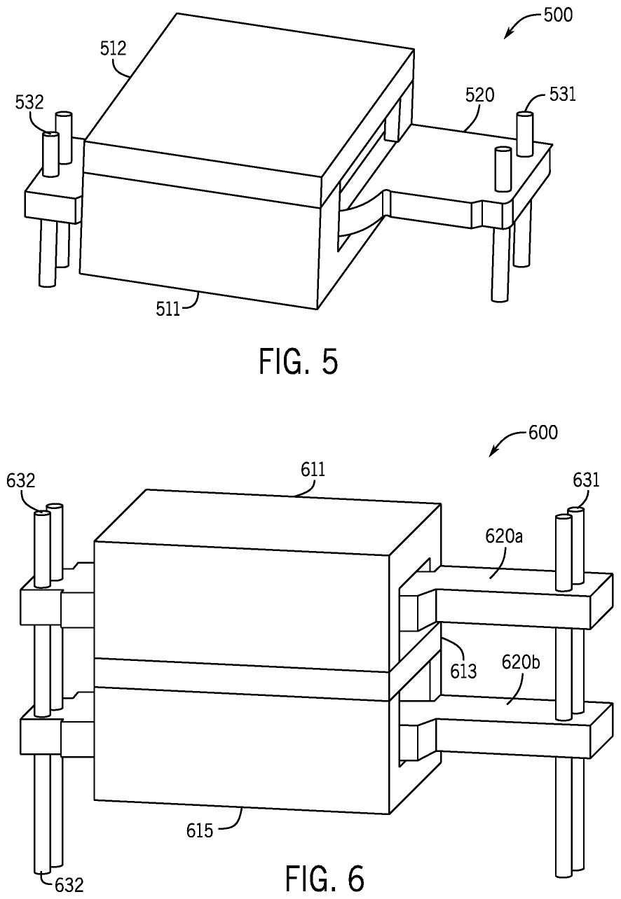

FIG. 6 illustrates a cellular PCB-based planar transformer 600. Construction of cellular planar transformer 600 is basically as described above with respect to FIGS. 3-5. The core of cellular planar transformer 600 can include core segments 611 and 615 corresponding to core segments 311 and 315 described above with respect to FIG. 3. The core can further include common core segment 613 corresponding to core segment 313 described above with respect to FIG. 3. Winding PCBs 620a and 620b can be positioned within the core windows formed by the configuration of core segments 611, 613, and 615, resulting in the windings (not shown in FIG. 6, but see FIG. 4) being positioned with respect to the cores as depicted in FIG. 3. Additionally, core segments 611, 613, and 615 may be sized and positioned to provide respective air gaps (e.g., between a center post of E-cores 611 and 615 and the face of I-core 613) as described above with respect to FIG. 3. Finally, primary winding pins 631 and secondary winding pins 632 may be provided as shown providing a parallel connection between the respective primary and secondary windings of the transformer cells, although other pin configurations could be used to provide series connections as described with respect to FIGS. 2A-2D. Thus, the transformer of FIG. 6 generally corresponds to the principles described above with respect to FIG. 3. It should be noted; however, that other core, PCB, winding terminal pin, and other configuration parameters could be used as appropriate for a given embodiment.

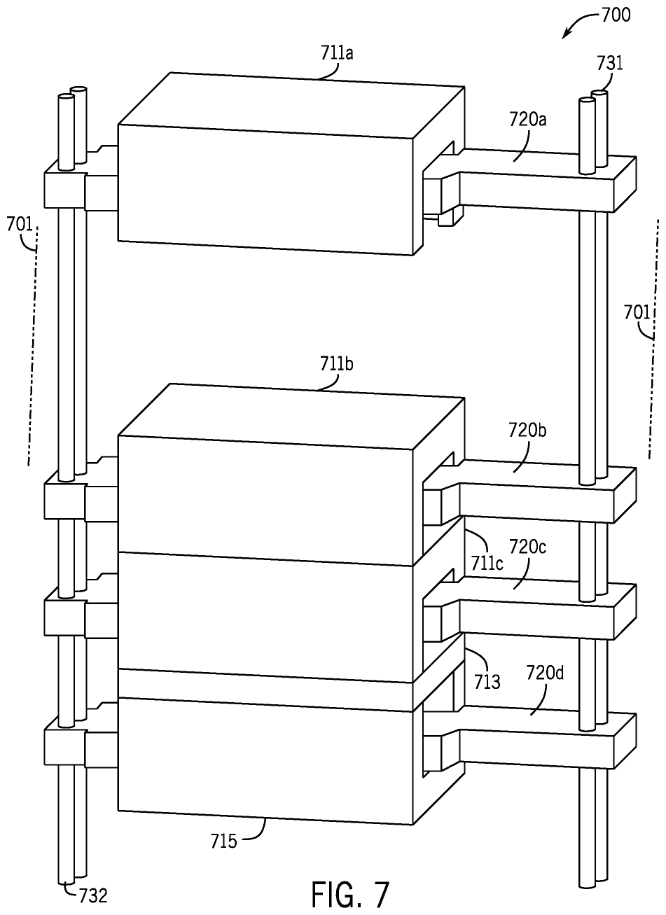

FIG. 7 illustrates an alternative cellular PCB-based planar transformer 700 made up of a number of cells “n” with four of the cells being depicted. Dashed lines 701 can correspond to the unillustrated cells. Cellular transformers can be constructed with any number of cells, as desired for a given embodiment. In the illustrated configuration, the core of cellular planar transformer 700 can include core segments 711a, 711b, 711c, and 715 corresponding to core segments 311 and 315 described above with respect to FIG. 3. The core can further include common core segment 713 disposed between core segments 711c and 715 and corresponding to core segment 313 described above with respect to FIG. 3. Using the exemplary E-cores of FIG. 7, additional I-cores are not needed between core segments 711a, 711b, and 711c because the “vertical” member of the E serves as the common core segment for these cores, meaning that there is no net flux in these core elements. As a result, core segments 711b and 711c can have a reduced thickness for the same reasons as common core elements as described above.

Winding PCBs 720a, 720b, 720c, and 720d can be positioned within the core windows formed by the configuration of core segments described above, resulting in the windings (not shown in FIG. 7, but see FIG. 4) being positioned with respect to the cores as depicted in FIG. 3. Additionally, core segments 711a, 711b, 711c, 713, and 715 may be sized and positioned to provide respective air gaps (e.g., between a center post of E-cores and corresponding common core segments shared between cells as described above with respect to FIG. 3. Finally, primary winding pins 731 and secondary winding pins 732 may be provided as shown providing a parallel connection between the respective primary and secondary windings of the transformer cells, although other pin configurations could be used to provide series connections as described with respect to FIGS. 2A-2D. Thus, the transformer of FIG. 7 generally corresponds to the principles described above with respect to FIG. 3. It should be noted; however, that other core, PCB, winding terminal pin, and other configuration parameters could be used as appropriate for a given embodiment.

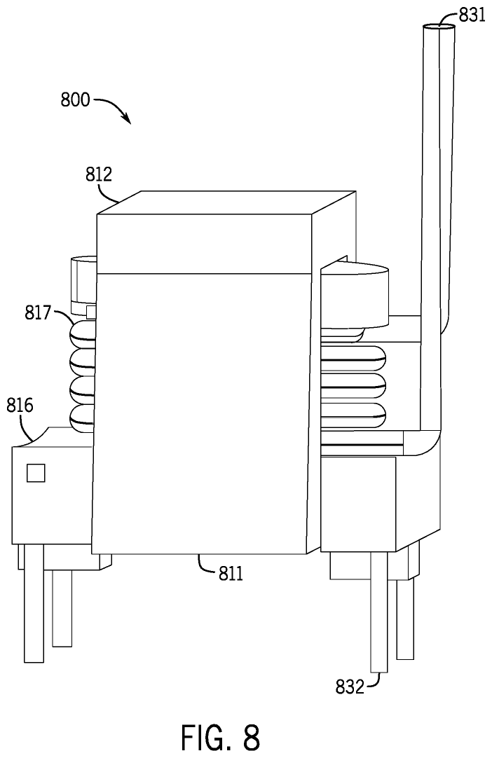

In other embodiments, a cellular flyback transformer could be constructed using a wire wound transformer. FIG. 8 illustrates an exemplary wire wound transformer 800, although numerous other configurations are also possible. The wire-wound transformer assembly can include a core formed from an E-shaped core segment 811 and an I-shaped core plate 812, with windings 817 being wound around a bobbin 816. (Only one set of windings is shown in the view of FIG. 8, but an additional winding could be disposed between windings 817 and bobbin 816, with winding terminals taken off in suitable fashion, either by flying leads 831 or on the bobbin pins 832. In any case, bobbin 816 and thus the associated windings 817 (and secondary windings not shown in the view of FIG. 8) being disposed about a center post (not shown due to perspective) of E-core 811. The primary winding can be connected by flying leads 831, and the secondary winding can be connected by bobbin pins 832 (or by flying secondary leads not shown in FIG. 8). As with the figures discussed above, the configuration of FIG. 8 is just one possible configuration illustrating the basic principles, and implementations can vary in structural details, such as the exact core shapes, winding terminal placement, winding and bobbin configuration, etc.

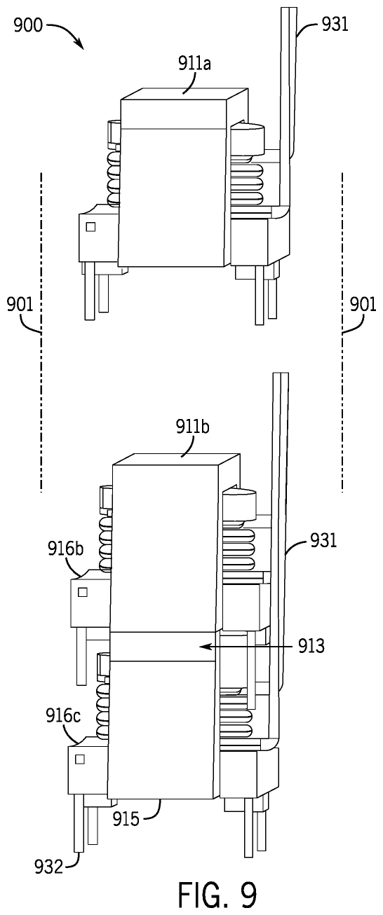

FIG. 9 illustrates a wire wound cellular transformer 900 that is broadly similar to the planar cellular transformer 700 of FIG. 7. More specifically, transformer 900 can be made up of a number of cells “n” with three of the cells being depicted. Dashed lines 901 can correspond to the unillustrated cells. Cellular transformers can be constructed with any number of cells, as desired for a given embodiment. In the illustrated configuration, the core of cellular planar transformer 900 can include core segments 911a, 911b, and 915 corresponding to core segments 311 and 315 described above with respect to FIG. 3. The core can further include common core segment 913 disposed between core segments 911b and 915 and corresponding to core segment 913 described above with respect to FIG. 3. Using the exemplary E-cores of FIG. 9, an additional I-core is not needed between core segments 911a and 911b because the “vertical” member of the E serves as the common core segment for these cores, meaning that there is no net flux in these core elements. As a result, core segment 911b can have a reduced thickness in the “vertical” member of the E for the same reasons as common core elements as described above.

Winding bobbins 916a, 916b, and 916c, along with the associated windings, can be positioned within the core windows formed by the configuration of core segments described above, resulting in the windings being positioned with respect to the cores as depicted in FIG. 3. Additionally, core segments 911a, 911b, 915, and 913 may be sized and positioned to provide respective air gaps (e.g., between a center post of E-cores and corresponding common core segments shared between cells as described above with respect to FIG. 3. Finally, primary winding leads 931 and secondary winding leads (similar but not shown in FIG. 9 or taken from bobbin pins 932) may be provided as shown providing a series or parallel connection (as desired) between the respective primary and secondary windings of the transformer cells. Thus, the transformer of FIG. 9 generally corresponds to the principles described above with respect to FIG. 3. It should be noted; however, that other core, winding, winding terminal leads, and other configuration parameters could be used as appropriate for a given embodiment.

Although described above in terms of flyback transformers/coupled inductors, the exact same principles can be used to construct cellular energy storage inductors using a discrete air gap. The only difference for an energy storage inductor embodiment would be the absence of a secondary winding. (It is noted that FIG. 3 already omitted express depiction of the secondary winding for illustration clarity. In FIG. 4, the PCB layers associated with the secondary winding could be omitted. In FIGS. 5-7, the PCB with only layers corresponding to a single winding could be used. In FIGS. 8-9, the second winding is not expressly depicted as it is located below the winding shown.).

The foregoing describes exemplary embodiments of cellular flyback transformers and cellular energy storage inductors using a discrete air gap. Such configurations may be used in a variety of applications but may be particularly advantageous when used in conjunction with power supplies for consumer electronic devices. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A cellular flyback transformer comprising:
a first magnetic core segment having a first primary winding and a first secondary winding wrapped around at least a portion of the first magnetic core segment; and
a second magnetic core segment having a second primary winding and a second secondary winding wrapped around at least a portion of the second magnetic core segment; and
a common magnetic core segment;
wherein the first, second, and magnetic core segments are joined such that:
there is a first air gap between at least a portion of the first magnetic core segment and the common magnetic core segment and a second air gap between at least a portion of the second magnetic core segment and the common magnetic core segment; and
magnetic flux in the common magnetic core segment induced by at least one of the first primary or first secondary winding is equal and opposite a corresponding magnetic flux in the common magnetic core segment induced by at least one of the second primary or second secondary winding.

2. The cellular flyback transformer of claim 1 wherein the first magnetic core segment and second magnetic core segment are E-cores, and the common magnetic core segment is an I-core.

3. The cellular flyback transformer of claim 2 wherein the first air gap is between a center post of the first magnetic core segment and the common magnetic core segment, and the second air gap is between a center post of the second magnetic core segment and the common magnetic core segment.

4. The cellular flyback transformer of claim 3 wherein the first primary and first secondary windings are disposed around the center post of the first magnetic core segment, and the second primary and second secondary windings are disposed around the center post of the second magnetic core segment.

5. The cellular flyback transformer of claim 4 wherein the cellular flyback transformer is a planar transformer, and the first primary and first secondary windings and second primary and second secondary windings are formed on respective layers of a printed circuit board.

6. The cellular flyback transformer of claim 4 wherein the cellular flyback transformer is a wire-wound transformer, and the first primary and first secondary windings and second primary and second secondary windings are wound about respective bobbins.

7. The cellular flyback transformer of claim 1 wherein the common magnetic core segment is integral with the second magnetic core segment.

8. The cellular flyback transformer of claim 7 wherein the first air gap is between a center post of the first magnetic core segment and the common magnetic core segment, and the second air gap is between a center post of the second magnetic core segment and an additional magnetic core segment.

9. The cellular flyback transformer of claim 1 wherein the common magnetic core segment has a reduced cross-sectional area relative to the first and second magnetic core segments.

10. The cellular flyback transformer of claim 1 wherein the first primary winding and the second primary winding are connected in parallel, and the first secondary winding and the second secondary winding are connected in parallel.

11. The cellular flyback transformer of claim 1 wherein the first primary winding and the second primary winding are connected in parallel, and the first secondary winding and the second secondary winding are connected in series.

12. The cellular flyback transformer of claim 1 wherein the first primary winding and the second primary winding are connected in series, and the first secondary winding and the second secondary winding are connected in parallel.

13. The cellular flyback transformer of claim 1 wherein the first primary winding and the second primary winding are connected in series, and the first secondary winding and the second secondary winding are connected in series.

14. A cellular magnetic energy storage component comprising:
a plurality of magnetic core segments each having at least one winding disposed about at least a portion thereof; and
at least one common magnetic core segment;
wherein the plurality of magnetic core segments and the at least one common magnetic core segment are joined such that:
there is an air gap between a portion of each of the plurality of magnetic core segments and the common magnetic core segment; and
magnetic flux in the at least one common magnetic core segment induced by one or more of the at least one windings substantially cancels a corresponding magnetic flux in the common magnetic core segment induced by one or more other at least one windings.

15. The cellular magnetic energy storage component of claim 14 wherein one or more of the at least one windings are connected in parallel.

16. The cellular magnetic energy storage component of claim 14 wherein one or more of the at least one windings are connected in series.

17. The cellular magnetic energy storage component of claim 14 wherein one or more of the at least one windings is formed on a printed circuit board.

18. The cellular magnetic energy storage component of claim 14 wherein one or more of the at least one windings is wound about a bobbin.

19. The cellular magnetic energy storage component of claim 14 wherein the at least one common magnetic core segment is integral with at least one of the plurality of magnetic core segments.

20. The cellular magnetic energy storage component of claim 14 wherein the at least one common magnetic core segment has a reduced cross-sectional area relative to the plurality of magnetic core segments.

21. The cellular magnetic energy storage component of claim 14 wherein the cellular magnetic energy storage component is an inductor.

22. The cellular magnetic energy storage component of claim 14 wherein the cellular magnetic energy storage component is a flyback transformer.
